(19) United States
(12) Patent Application Publication
(10) Pub. No.: US 2011/0132526 A1
(43) Pub. Date: Jun. 9, 2011

(54) DEVICE AND METHOD FOR GLUING TWO OR MORE PAPER WEBS OR PLIES

(76) Inventor: Stefano Petri, SoGiuese (IT)

(21) Appl. No.: 13/054,843

(22) PCT Filed: Jul. 16, 2009
(86) PCT No.: PCT/IT09/00312

§ 371 Date: Jan. 19, 2011

(30) Foreign Application Priority Data
Jul. 21, 2008 (IT) FI2008A000134

(51) Int. Cl. B29C 59/04

(52) U.S. Cl. 156/209; 156/578

(57) ABSTRACT

Device for gluing two or more paper webs or plies, comprising gluing means destined to apply glue to a paper ply (N2) and pressure means which are located downstream of said gluing means and press more paper plies (N1, N2; N3) onto each other determining their coupling. The said gluing means comprise at least one body (1) provided with corresponding reliefs (R1) which apply the glue on predetermined gluing zones or areas of a paper ply (N2) advancing along a predetermined direction (F2) and the said at least one gluing body (1) is the final roller of a gluing unit (C).

The present invention relates to a device and a method for gluing two or more plies or strips of paper.

In particular, this invention can be applied in the production of ribbon-multilayered material used to make rolls of paper towels, toilet paper and similar products.

It is known that the in production of web-multilayer material used to make rolls of paper towels, toilet paper and similar products use is made of units comprising embossing rollers with an engraved roller and a counter-roller having a smooth elastic surface, between which at least a ply is embossed, and gluing rollers for distributing liquid glue on the engravings (e.g. pyramid relief) of the engraved roll. In this way, the glue is transferred to the ply being embossed. The final union of the embossed ply with an additional ply, which can also be embossed or otherwise smooth, is due to a pressure roller that is located downstream of the embossing unit and exerts a predetermined pressure on the plies to be coupled. The engraved roller can be provided with further relief than those who make the embossing itself. By shaping appropriately such further relief, the glue is transferred only on areas or zones of the ply being embossed, so that, using coloured glue, the finished product exhibits ornamental or decorative effects corresponding to the shape of the said further relief.

A remarkable disadvantage of this type of system is that the engraved roll must be replaced whenever necessary to make a product with different decorations, which, given the time required for the replacement and the high cost of the engraved roller, is incompatible with the current production requirements.

The main purpose of this invention is to permit the bonding of two or more plies or strips of paper and, at the same time, the production of paper webs with decorative motifs or decorations that improve its appearance, eliminating or at least reducing the disadvantages of the prior art. This result has been achieved, according to the present invention, by adopting the idea to realize a device and a method having the characteristics described in the independent claims. Further characteristics of the present invention are the object of the dependent claims.

Thanks to the present invention, it is possible to join two or more plies or strips of paper to each other and, simultaneously, produce ornamental or decorative effects on the material being processed. In addition, a device in accordance with the present invention is relatively simple, inexpensive, reliable and does not require the intervention of specialized personnel. Furthermore the so-called “decoration exchange”, i.e. the change in the decorative or ornamental effect on the final product, is particularly quick and easy, since it is sufficient to remove the jacket of the glue applicator roller from the core thereof and replace said jacket with another one.

These and further features and advantages of the present invention will be better understood by anyone skilled in the art from a reading of the following description in conjunction with the attached drawings, given as a practical exemplification of the invention but not to be considered in a limitative sense, wherein:

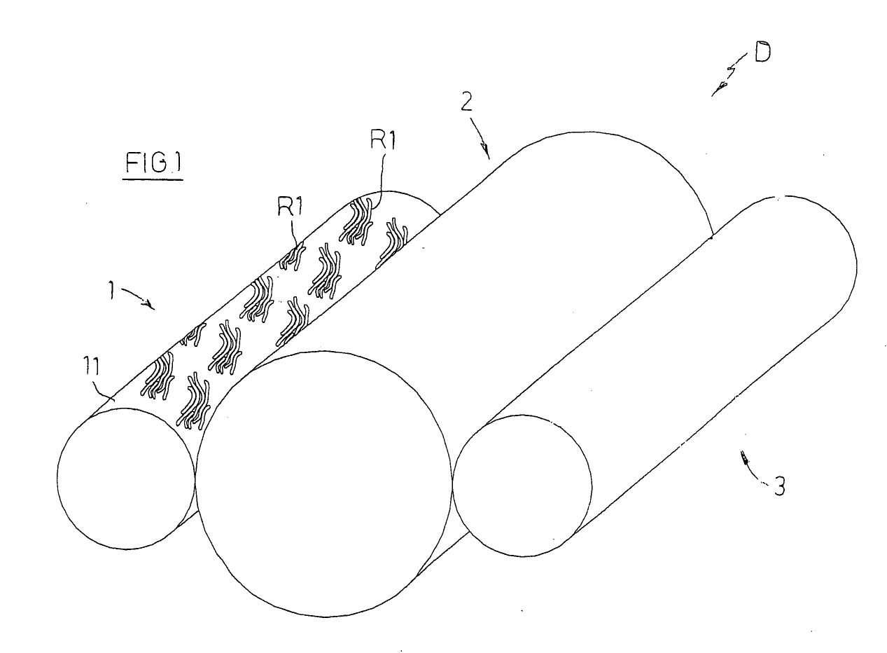

FIG. 1 schematically represents a device in accordance with the present invention;

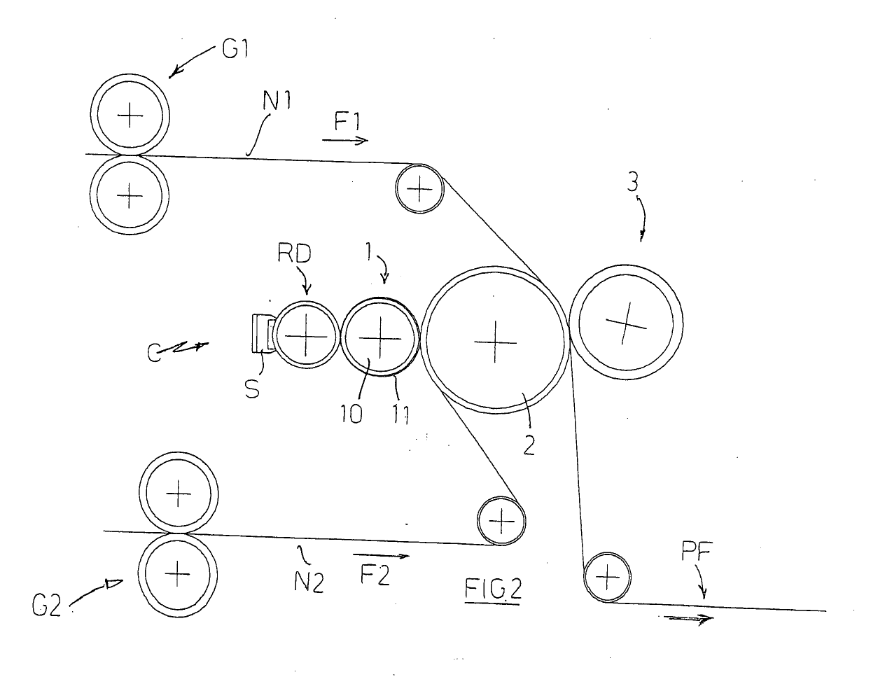

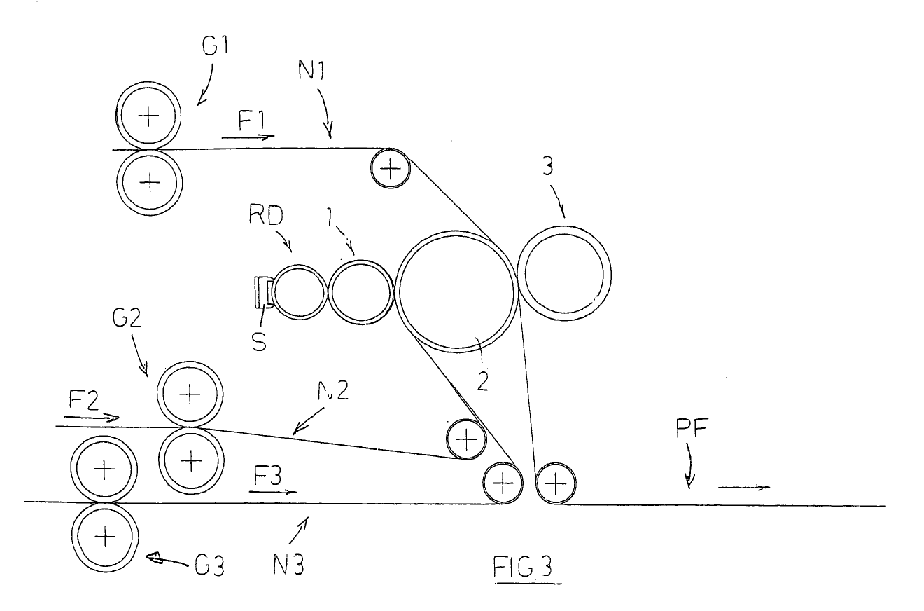

FIGS. 2 and 3 are two examples concerning the use of the device shown in FIG. 1;

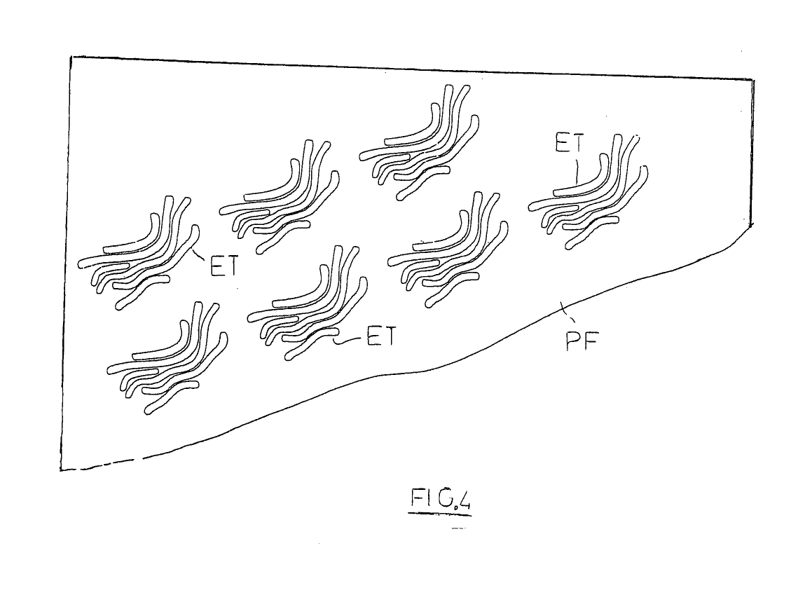

FIG. 4 schematically represents an effect achieved by applying a device in conformity with the invention according to the diagrams of FIG. 2 or FIG. 3;

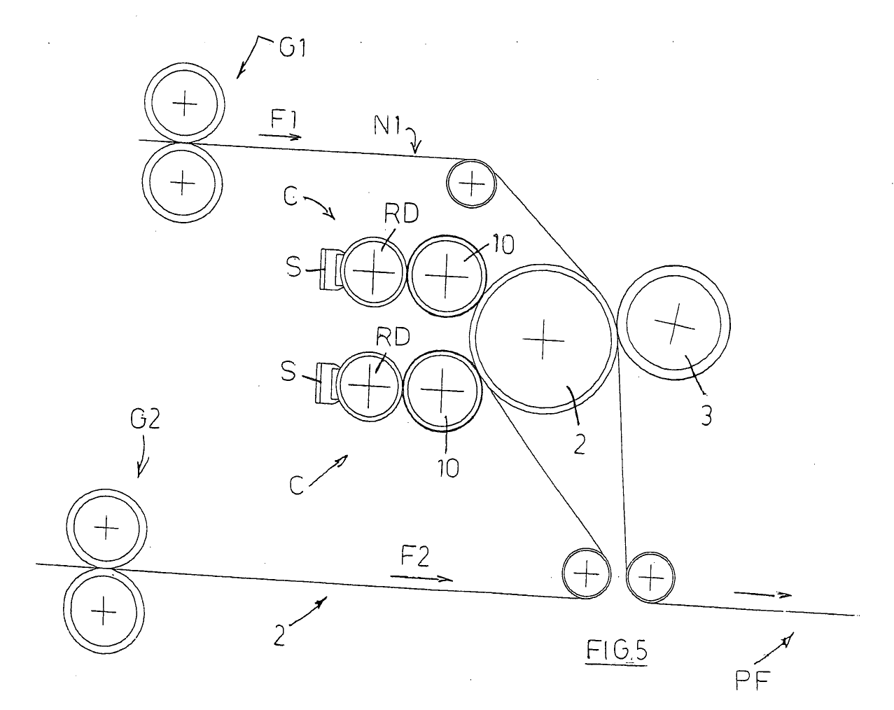

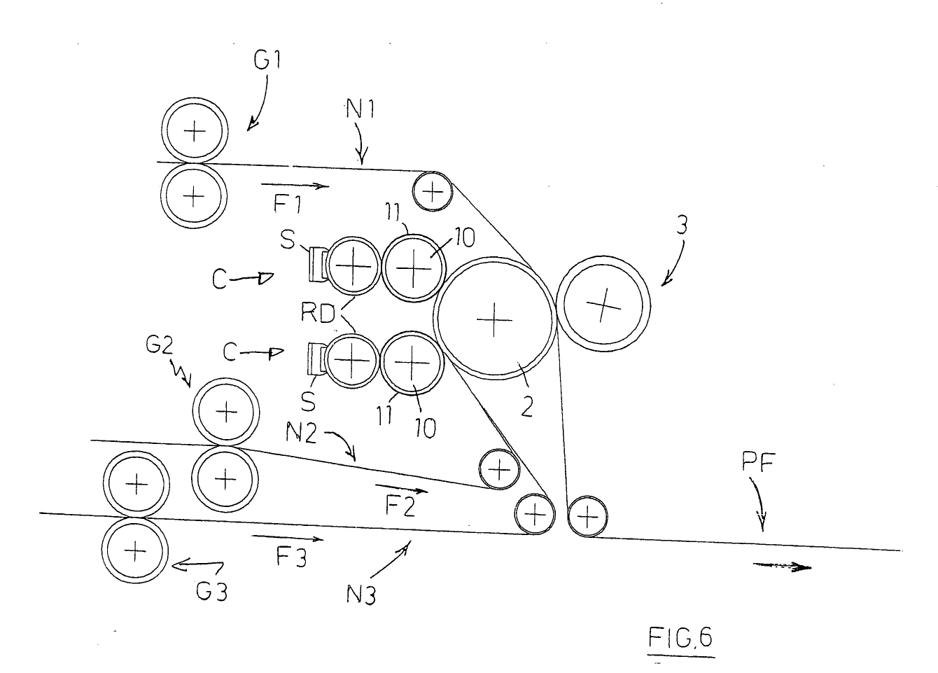

FIGS. 5 and 6 are two further schemes concerning the use of a device in accordance with the present invention;

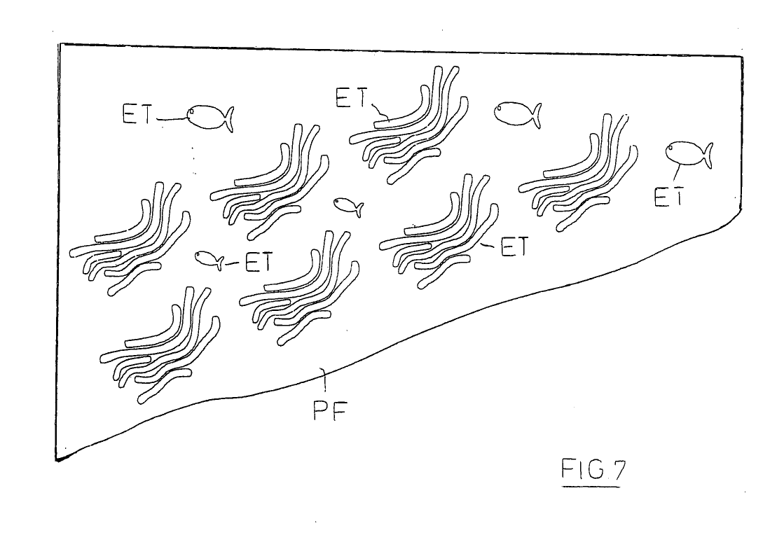

FIG. 7 represents schematically the effect obtainable by applying a device in conformity with the invention according to the diagrams of FIG. 5 or FIG. 6.

In FIG. 1 a device in accordance with the present invention is denoted as a whole by the reference “D”. This device comprises three rollers (1, 2, 3) arranged with their longitudinal axes parallel to each other. The first roller (1) is a glue applicator roller of a gluing unit. The second roller (2) is a smooth roller which, as further described below, guides and supports the plies being bonded. The third roller (3) is a pressure roller. The second roller (2) is positioned between the first roller (1) and third roller (3). As further shown in the diagrams of FIG. 2, FIG. 3, FIG. 5 and FIG. 6, the first roller (1) is the terminal element of a gluing unit (C) that includes a tank (S) containing liquid glue (preferably coloured glue), a distributor roller (RD) and a terminal roller that is constituted by the first roller (1) of the device (D). The distributor roller (RD), rotating around its longitudinal axis, removes the glue from the tank (S) and distributes it on the surface of the roller (1). When a paper ply comes into contact with the roller (1), the latter applies on the paper ply the glue received through the distributor roller (RD).

The said roller (1) consists of a tubular or cylindrical core (10) on which there is mounted a removable tubular jacket (11). The said tubular jacket has a number of relief (R1) of predetermined shape which are distributed on its outer surface according to a predetermined pattern.

In this way, the first roller (R1) of the device (D) is provided, on its outer surface, a series of relief (R1) having a predetermined shape and distributed according to a predefined pattern.

Also, if the roller (1) consists of a core (10) on which it is fit a removable jacket (11), it is sufficient to replace the latter when a change of the motifs made on the finished product is required.

With reference to the examples shown in the attached drawings, the said relief (R1) have the shape of corrugated segments. The second roller (2) of the device (D) may be of greater diameter than the first roller (1), as exemplified in the attached drawings. FIG. 2 shows an example of use of the present invention: two plies of paper (N1, N2) pass through two corresponding embossing units (G1, G2), advancing along the direction indicated by the arrows (F1) and (F2). The ply (N2) passes, downstream of the embossing (G2), between the first roller (1) and the second roller (2) of the device (D), while the ply (N1) passes, downstream of the respective embossing unit (G1), between the second roller (2) and the third roller (3) of the same device (D). The two plies (N1, N2) are glued to each other by effect of the pressure exerted on them by the third roller (3) of the device (D) while both are close to the second roller (2). While it passes on the roller (1), the ply (N2) is glued in correspondence of the areas or zones having the shape and the size of the relief (R1) of the first roller (1). In addition, the pressure exerted by the roller (3) on the plies (N1, N2) is concentrated on areas or zones corresponding to the shape and size of the relief (R3) of the third roller (3). Therefore, as shown in FIG. 4, on the product exiting the device (D), denoted by the reference “PF” in the attached drawings, there are effects (ET) that are visible in transparency and that are due to the colour of the glue.

The alternative scheme illustrated in FIG. 3 provides the treatment of three paper plies (N1, N2, N3) rather than two, embossed by corresponding embossing units (C1, G2, G3). As in the scheme of FIG. 2, the ply (N2) comes into direct contact with the reliefs (R1) of the roller (1), while the ply (N1) comes into direct contact with the roller (3). Between the veils (N1) and (N2) there is interposed the ply (N3), which, therefore, comes into direct contact with the roller (2). The effects on the material (PF) in output from the device (D) are shown in FIG. 4.

Referring to FIG. 5 and FIG. 6, the said first roller (1) is doubled, providing two gluing units (C), with a roller (1) constituting the terminal roller of each gluing unit and with the two gluing units (C) arranged in cascade along the advancing direction (F2) of the ply (N2). The two gluing units may apply glue of the same colour or of two different colours (one colour for the glue of a gluing unit and a different colour for the glue of the other gluing unit). The two rollers (1) may exhibit surface reliefs of the same size and shape or of different shape and/or size. The effects produced using rollers (1) having differently shaped reliefs are illustrated in FIG. 7. In practice, each of the rollers (1) applies coloured glue in correspondence of zones or areas of the ply (N2) which correspond to the shape and size of the respective reliefs (R1). Therefore, when the plies (N1, N2) join to each other passing between the guide and support (2) roller and the pressure roller (3), on the finished product (FP) it is possible to see effects (which are differentiated if the reliefs of a roller 1 are different from those of the other roller 1) due, as in the examples described above, to the visibility of coloured glue (ET) in transparency through the ply (N1).

The diagram of FIG. 6 concerns the treatment of three plies (N1, N2, N3) instead of two. The operation of the device is identical to that described with reference to the diagram of FIG. 5. The effects on the finished product (FP) are shown in FIG. 7.

The central roller (2) of the device (D) guides and supports the stripes or plies (N1, N2, N3) in treatment. In fact, the plies (N2) and (N3) are guided on the roller (2) during their advancing (F2, F3) and at the same time these plies bear on this roller while the gluing roller or rollers (1) apply the glue on them. And on the same roll (2) all the plies (N1, N2, N3) are supported while the pressure roller (3) presses on them to determine their bonding.

In practice, the gluing or application of glue involves areas or zones of a ply of paper (N2). The shape and size of these gluing areas or zones correspond to those of the relief (R1) of the gluing roller or rollers (1) of the device (D). They are visible in transparency through the finished product.

The observable effect on the finished product can be varied by changing the shape, size and patterning of the reliefs (R1).

As said before, the glue contained in the tank of the gluing unit (C) can be coloured glue. However, the glue can also be not coloured. In this case, on the finished product no special decorative effects can be seen; however the bonding of the paper plies takes place, particularly in correspondence of the glued areas.

Since the deformation provoked on the paper plies by the reliefs (R1) of the gluing roller or rollers (1) is localized, the apparent thickness of the finished product due to the embossing of the individual plies is not significantly reduced.

In addition, a ply or more plies or all of the plies (N1, N2, N3) may be smooth, i.e. not embossed.

An operative method in accordance with the present invention provides for a step of applying glue (coloured or not) on a paper ply (embossed or not) in correspondence of zones or areas of the paper ply, and, in a subsequent step of bonding the said paper ply to a further paper ply (embossed or not), it comprises exerting a pressure on the plies to be bonded, so that on the finished product there can be observed the zones or areas subject to gluing (ET).

Practically, the construction details may vary in any equivalent way as far as the shape, dimensions, elements disposition, nature of the used materials are concerned, without nevertheless departing from the scope of the adopted solution idea and, thereby, remaining within the limits of the protection granted to the present patent.

1. A device for gluing two or more paper webs or plies, the device comprising:
a gluing means for applying glue to a paper ply; and
a pressure means located downstream of said gluing means for pressing more paper plies onto each other determining a coupling of said paper plies, said gluing means comprising at least one body provided with corresponding reliefs which apply the glue on predetermined gluing zones or areas of a paper ply advancing along a predetermined advancing direction, said at least one gluing body being a final roller of a gluing unit, said gluing means comprising two gluing units, each of said two gluing units comprising one said final roller, said final roller defining a terminal roller of each said gluing unit and said two gluing units being arranged in cascade along the advancing direction of said paper ply, said two gluing units applying glue of a same colour or two different colors, said two rollers exhibiting surface reliefs of a same size and shape or of one or more of a different shape and size.

2. A device according to claim 2, wherein said gluing unit comprises a tank containing colored glue.

3. A device according to claim 1, wherein said pressure means comprises a roller.

4. A device according to claim 1, wherein a further roller is provided between said gluing and said pressure roller, said further roller guiding and supporting paper plies during the gluing and coupling of the paper plies.

5. A device according to claim 1, further comprising one or more embossing units located upstream of said gluing means and said pressure means, said paper plies being embossed via said one or more embossing units.

6. A device according to claim 1, wherein said reliefs are provided by a skirt removably fitted on said body.

7. A method for coupling two or more paper webs or plies by gluing, the method comprising:
applying glue on predetermined gluing zones or areas of a paper web or ply, said gluing zones or areas having a shape of reliefs provided by a body contacted by said paper web or ply during said gluing, said body being a final roller of a gluing unit, said gluing means comprising two gluing units, each of said two gluing units comprising one said final roller, said one said final roller defining a terminal roller of each gluing unit and said two gluing units being arranged in cascade along an advancing direction of said paper ply, said two gluing units applying glue of a same color or two different colors, said two rollers comprising surface reliefs of a same size and shape or of one or more of a different shape and size.

8. A method according to claim 7, wherein one or more paper plies are embossed before performing said gluing.

9. A method according to claim 7, wherein said gluing step is executed with colored glue.
